(19) United States
(12) Patent Application Publication
(10) Pub. No.: US 2003/0097506 A1
(43) Pub. Date: May 22, 2003

(54) Structure of the bus card of the mini image port

(75) Inventor: Yung-Shun Chuang, Hsin-Tien City (TW)

Correspondence Address: BACON & THOMAS, PLLC, 625 SLATERS LANE, FOURTH FLOOR, ALEXANDRIA, VA, 22314

(73) Assignee: AAEON Technology Inc., Taipei (TW)

(21) Appl. No.: 09/988,551

(22) Filed: Nov. 20, 2001

(51) Int. Cl. G06F 13/00

(52) U.S. Cl. 710/301

(57) ABSTRACT

A kind of “structure of display card of mini image port bus” concerns providing a VGA display card with an upgraded space: which, after redefining the signal from the connector on the memory in a notebook computer, enhances the added use value by enlarging the calculation capability of the enlarged 3-D space with the display card installed on the image port of the long card.

### BACKGROUND OF THE INVENTION

1. Field of the Invention

This invention concerns a device which can provide a VGA display card with an upgrade space.

2. Description of Related Art

In an advanced image port in a desktop motherboard, it can not be applied to a long card because it uses a vertical insert in the direction when inserted. (Refer to FIG. 3 and FIG. 4.) With an ordinary long card, there are only an industrial-standard frame bus (A) on a golden finger and a bus (B) connected to a peripheral device. Only when a golden finger and a backplate (C) are connected together, as shown in FIG. 4, can it be used as an expansion channel through an industrial-standard frame bus (A) on a backplate (C) and a bus (B) connected with a peripheral device; however, given that the image card (E) of the current high-level image bus has no longer provided support to an industrial-standard frame bus (A) and a bus connected to a peripheral device, to enlarge the enhancement space of the long card without using an advanced image port (F) of the desktop motherboard at the same time, this question must be resolved fast by the industry.

### SUMMARY OF THE INVENTION

The main purpose for this invention is to redefine the signal from the connector on the memory set in a notebook computer in order to expand the 3-D calculation capability to enhance the product's added use value.

### BRIEF DESCRIPTION OF THE DRAWINGS

FIG. 1 a general representation of the embodiment of this invention.

FIG. 2 a representation of connectors distributed for this invention.

FIG. 3 a representation of the embodiment of a conventional invention.

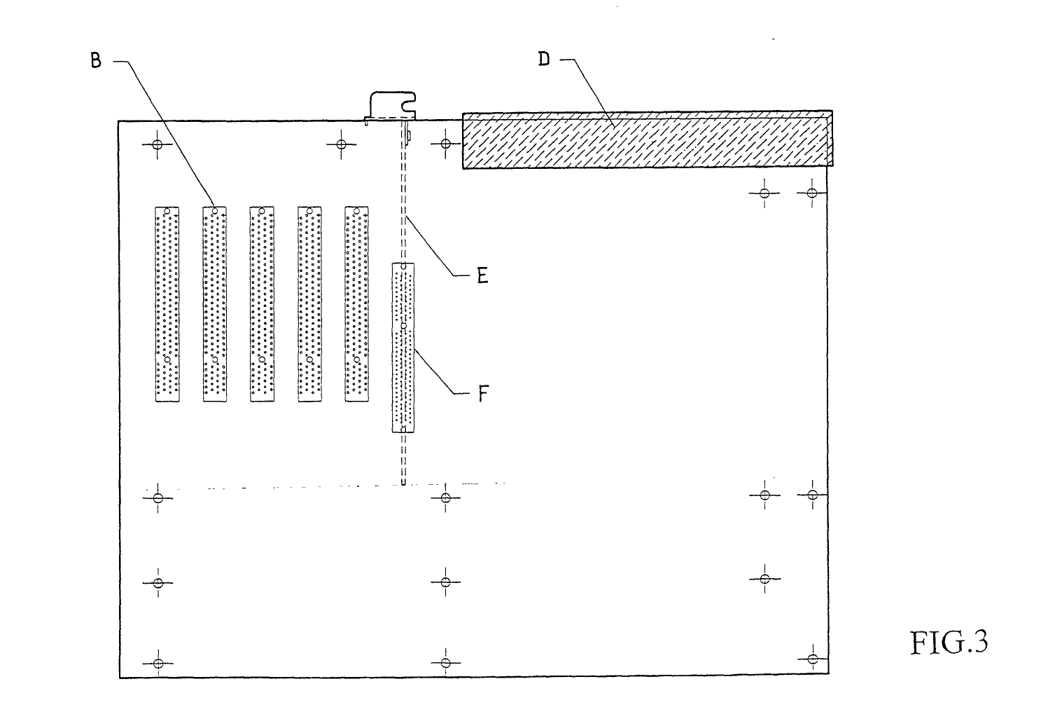

FIG. 4 a presentation of the embodiment of another conventional invention.

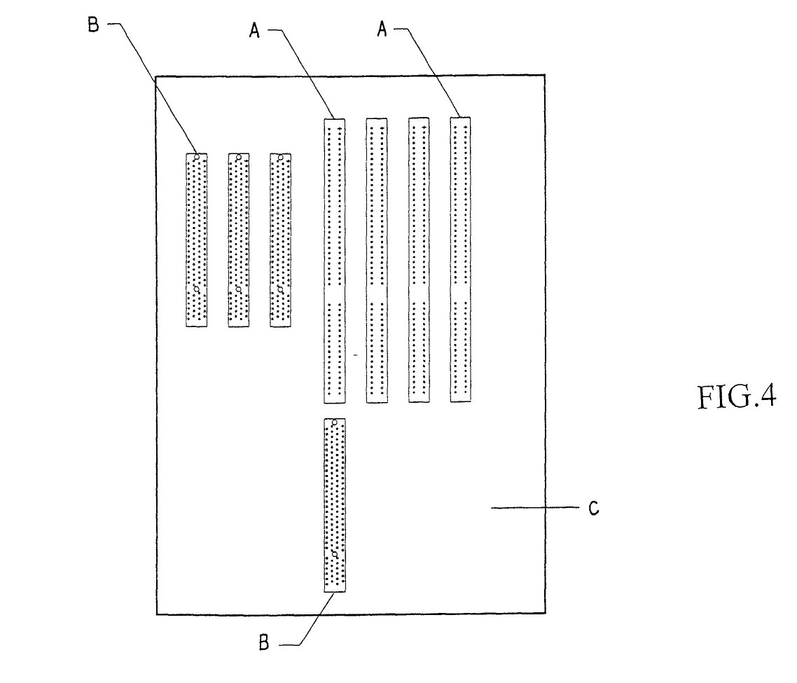

### DETAILED DESCRIPTION OF THE PREFERRED EMBODIMENT

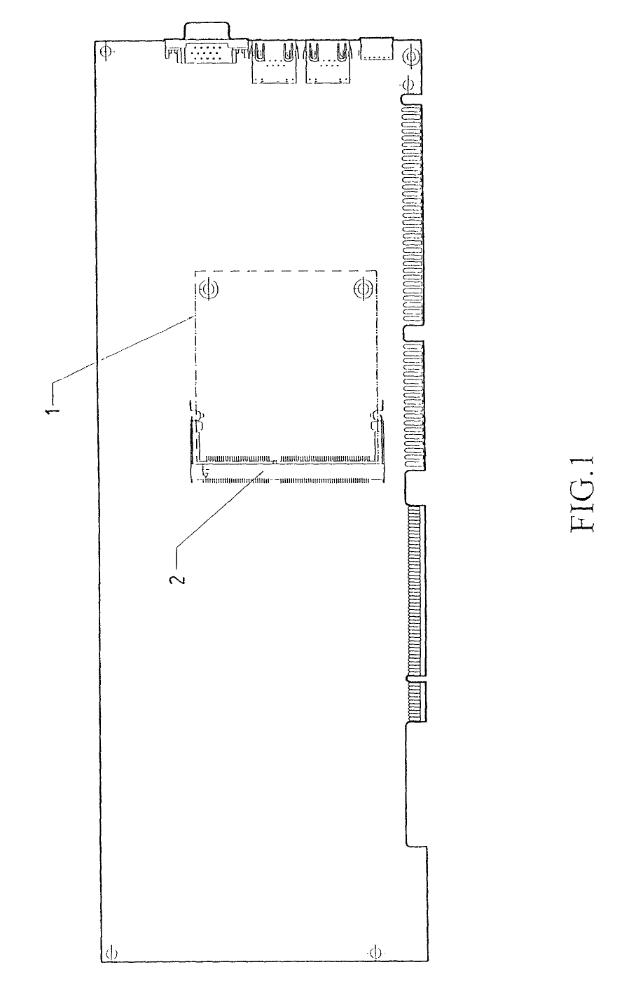

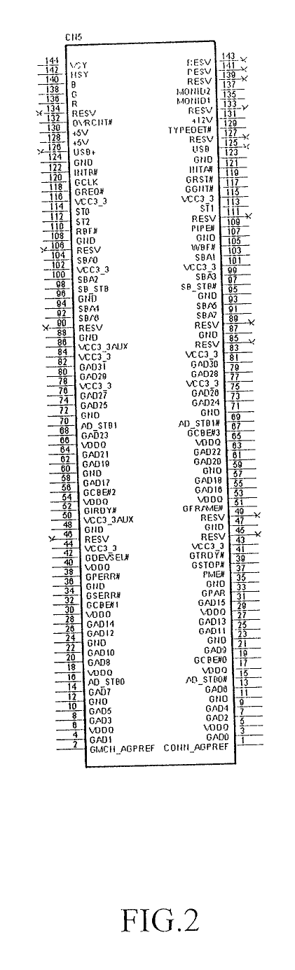

Refer to FIG. 1 and FIG. 2. The display card (1) of the mini image port bus is small in shape and is easy for the integration of the circuit device. Furthermore, the function of the image in the chipset on the plate can detect if there is a display card (1) of the mini image port bus inserted. If the display card (1) of the mini image port bus is inserted, the function of the image in the chipset on the plate will be enabled to stop but the image on the display card (1) at the mini image port bus will have a connection with the image on the plate and the signal will be sent to the connector (3) of the image of the long card in such way that some cost can be saved and the environmental burden can be diminished by saving an image connector (3) and a connection line.

In this way, depending on the demand of the performance of the VGA, the user can add the display optionally to expand the 3-D calculation capability. It's easy and simple to upgrade the long card VGA, which has been a bottleneck that is not easy to be upgraded, to increase the product's added value.

To summarize the above, the structure revealed by this invention has never been found before and can indeed acquire the above-mentioned effect. Therefore, with the new type of patent document prepared to be submitted for a new type of patent under the regulations, hopefully you will carry out the inspection in detail and thereby grant us a patent. We will appreciate it very much.

What is claimed is:

1. A kind of “structure of display card of mini image port bus” contains:
A connector which is used on the memory in a notebook computer and is small in shape; a display card of a mini image port bus which is easily assembled and enables the function of the image in the chipset on the plate to stop operation. The image on the display of the mini image port bus can make a connection with the image on the plate and send the signal to the connector of the image of the long card.
